(19) United States
(12) Patent Application Publication
(10) Pub. No.: US 2005/0265772 A1
(43) Pub. Date: Dec. 1, 2005

(54) Scrubbing brush shell and soap dish

(76) Inventor: Eddy Antoine, Trumbull, CT (US)

Correspondence Address: THEODORE JAY;SUITE 600, 16 N CHATSWORTH AVE., LARCHMONT, NY, 10538, US

(21) Appl. No.: 10/865,325

(22) Filed: Jun. 10, 2004

Related U.S. Application Data
(63) Continuation-in-part of application No. 10/856,504, filed on May 28, 2004.

(51) Int. Cl. A47K 7/02; B43K 8/10

(52) U.S. Cl. 401/201

(57) ABSTRACT

A thin vertically elongated plastic shell has a front surface of convex shape that as viewed in a vertical plane defines a vertical ellipse. The shell has a rear vertical surface, the front and rear surfaces enclosing a hollow interior. The rear surface has a centrally disposed elongated slot communicating with the hollow interior. The slot detachably receives a bar of soap. The slot is surrounded by a horizontally projecting wall and is otherwise flat. A flexible thin rubber like coating is secured to the front surface of the shell. The coating has an exposed surface which is secured to the front shell surface and provided is provided with a plurality of elements which are curved to conform to the curvature of the exposed coating surface and are supported thereby.

### CROSS REFERENCE TO COPENDING APPLICATION

The present application is a continuation-in-part of co-pending application entitled APPLICATOR-SCRUBBER, Ser. No. 10/856504, filing date May 28, 2004

### BACKGROUND OF THE INVENTION

It is often necessary to use hand held devices to apply soap to the skin of a human subject and/or scrub the previously applied soap on the skin and clean it. The present invention is directed toward a novel device of this type that can be manufactured inexpensively and easily used.

### SUMMARY OF THE INVENTION

In the aforementioned application, a hand held device employs a thin vertically elongated plastic member which in horizontal cross section defines an arc of a circle. The arcs at the top and bottom of the member are longer than the arcs of uniform length between the ends. The member has opposed inner and outer surfaces. The inner surface is disposed adjacent the hand of a user when the device is in use. The hand then engages the opposite vertical edges of the member.

The device also employs a flexible thin rubber like coating secured to the outer surface of said member. This coating has an exposed surface conforming to said outer surface and is provided with plurality of elements which are curved to conform to the curvature of the exposed coating surface and vertically spaced apart.

In accordance with the present invention, a hand held device is adapted for applying soap to the skin of a human subject or/or scrubbing the previously applied soap on the skin. The device employs a thin vertically elongated plastic shell having a front surface of convex shape that as viewed in a vertical plane defines a vertical ellipse. The shell has a rear vertical surface. The front and rear surfaces enclose a hollow interior.

The rear surface has a centrally disposed elongated slot communicating with said hollow interior. The slot is adapted to detachably receive a bar of soap. The slot is surrounded by a horizontally projecting wall and is otherwise flat.

A flexible thin rubber like coating is secured to the front surface of said shell. The coating has an exposed surface conforming to said front shell surface and is provided with plurality of elements which are curved to conform to the curvature of the exposed coating surface and are supported thereby. The elements extend outward from the coating and are vertically spaced apart.

In use, the device with the bar of soap in position can be held in the hand of a user with the soap exposed to apply the soap to the skin of the human subject. When the bar of soap is removed, the user can insert a hand into the slot and shell interior and apply the front surface with the elements to exert a scrubbing action.

### BRIEF DESCRIPTION OF THE DRAWINGS

FIG. 1 is a front view of a preferred embodiment of the invention.

FIG. 2 is a side view thereof with the removable soap bar shown in dotted line.

FIG. 3 is a rear view thereof.

FIG. 4 is a cross sectional view with the bar of soap removed and a hand of a user inserted.

### DETAILED DESCRIPTION OF PREFERRED EMBODIMENT

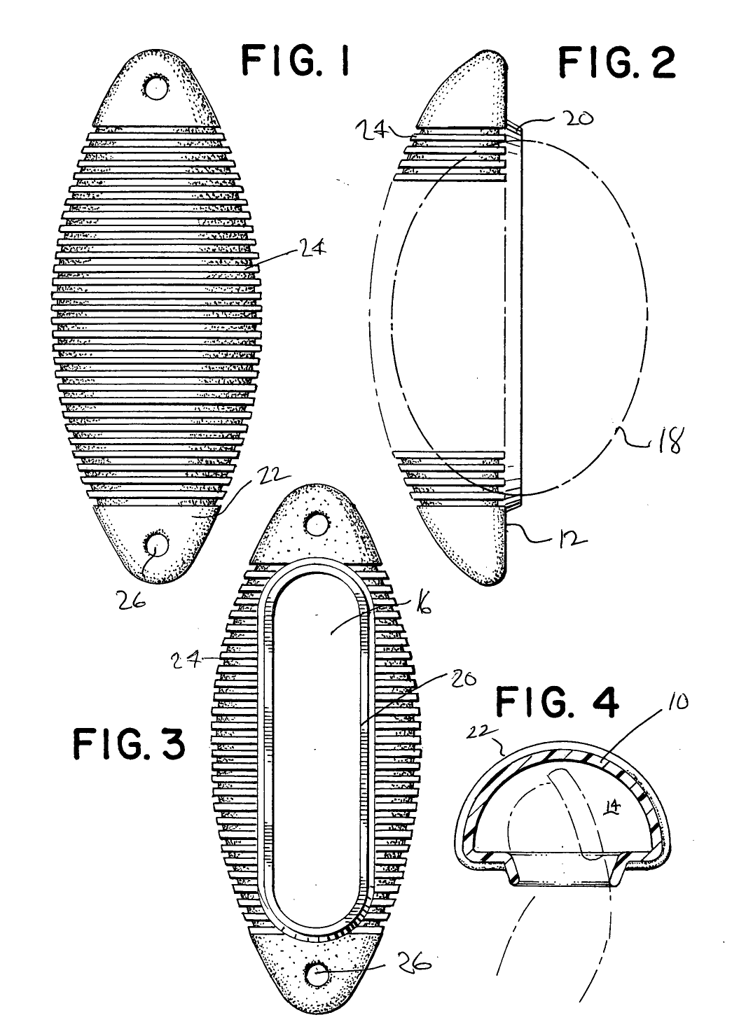

Referring now to FIGS. 1-4, there is illustrated a hand held device for applying soap to the skin of a human subject or/or scrubbing the previously applied soap on the skin.

The device employs thin vertically elongated plastic shell having a front surface 10 of convex shape that as viewed in a vertical plane defines a vertical ellipse. The shell has a rear vertical surface 12. The front and rear surfaces enclose a hollow interior 14. The rear surface has a centrally disposed elongated slot 16 communicating with said hollow interior. The slot being adapted to detachably receive a bar of soap 18, said slot being surrounded by a horizontally projecting wall 20 and being otherwise flat.

A flexible thin rubber like coating 22 secured to the front surface of said shell. The coating has an exposed surface conforming to said front shell surface and is provided with plurality of elements 24 which are curved to conform to the curvature of the coating and extend outward therefrom. Front and bottom ends of the front surface are covered by the coating but are free from the elements. Each end has a hole 26 extending through the shell.

The coating is glued to the outer surface of the member.

While the invention has been described with particular reference to the detailed description and drawing, the protection solicited is to be limited by the claims which follow.

1. A hand held device for applying soap to the skin of a human subject or/or scrubbing the previously applied soap on the skin, said device comprising:
a thin vertically elongated plastic shell having a front surface of convex shape that as viewed in a vertical plane defines a vertical ellipse, said shell having a rear vertical surface, said front and rear surfaces enclosing a hollow interior, the rear surface having a centrally disposed elongated slot communicating with said hollow interior, said slot being adapted to detachably receive a bar of soap, said slot being surrounded by a horizontally projecting wall and being otherwise flat; and
a flexible thin rubber like coating secured to the front surface of said shell, said coating having an exposed surface conforming to said front shell surface and provided with plurality of elements which are curved to conform to the curvature of the exposed coating surface and are supported thereby, said elements extending outward from the coating and being vertically spaced apart.

2. The device of claim 1 wherein said hollow interior is shaped for conforming to the shape of the soap bar.

3. The device of claim 2 wherein the top and bottom ends of the front surface of the shell are covered by said coating but are free of said elements.

4. The devise of claim 3 wherein each of said ends has a hole extending completely through the shell.
